(19) United States
(12) Patent Application Publication
(10) Pub. No.: US 2018/0206448 A1
(43) Pub. Date: Jul. 26, 2018

(54) System and Method for Dairy Farm Management

(71) Applicant: SONY CORPORATION, TOKYO (JP)

(72) Inventors: VIDYASHREE MADHUSUDAN, Bangalore (IN); PRABAKARAN RAMALINGAM, Bangalore (IN); RAKESH ROY, Bangalore (IN); ARUN GUNASEKARAN, Bangalore (IN); ASKI MALLANAGOUDA, Bangalore (IN); MADHVESH SULIBHAVI, Bangalore (IN)

(21) Appl. No.: 15/412,918

(22) Filed: Jan. 23, 2017

(51) Int. Cl. A01K 5/02; A01K 29/00; A01K 11/00; A01K 27/00; A01J 1/00; G06K 9/00; G06Q 10/06

(52) U.S. Cl. CPC A01K 5/0275; A01K 29/005; A01K 11/006; G06Q 10/0635; A01J 1/00; G06K 9/00711; A01K 27/009

(57) ABSTRACT

A system and method for animal feed management for a dairy farm, include a feed management server configured to monitor activities of a plurality of entities in a defined area of the dairy farm by a plurality of sensing devices. The monitored activities include at least a free-style grazing activity by a plurality of dairy animals included in the plurality of entities. An amount of milk yielded by each dairy animal of the plurality of dairy animals is estimated based on the monitored activities. A feed composition for each of the plurality of dairy animals is determined based on the determined amount of milk yielded by corresponding dairy animal and the monitored activities. A loading device, which loads a feed container with the determined feed composition for the first dairy animal, is controlled to manage consumption of the feed composition by the first dairy animal.

### CROSS-REFERENCE TO RELATED APPLICATIONS/INCORPORATION BY REFERENCE

None.

### FIELD

Various embodiments of the disclosure relate to dairy farm management. More specifically, various embodiments of the disclosure relate to an animal feed management system for a dairy farm.

### BACKGROUND

Recent advancements in dairy farming have led to the emergence of various smart dairy units, where a large number of dairy animals are kept under the surveillance of various care-takers. These care-takers collect milk from the dairy animals, which is further sold or stored for various purposes. Usually, in dairy farms all the dairy animals are fed at a common feeding platform. Thus, the feed composition for all the dairy animals is same, irrespective of the nutrition requirement of the individual dairy animal or variation in consumption by the individual dairy animal. Consequently, some dairy animals may be overfed while others are underfed, which may not be desirable. Further, health and nutrition requirement of dairy animals are usually monitored separately either by different health practitioners, responsible care-takers or by use of different automated monitoring systems. However, it may be difficult to estimate the feed composition based on a synchronization or re-calibration of the nutrition requirements based on the monitored health in real time or near-real time.

Further, in scenarios where dairy animals are allowed to have free-style grazing, the difficulty to track consumption for each of dairy animals increases, thereby leading to error-prone feed management for the dairy animals. Generally, care-takers may be assigned for management of various tasks related to the dairy animals, however keeping a track of the activities of those care-takers in a dairy farm in addition to activities of the dairy animals may be challenging task.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An animal feed management system and method for a dairy farm is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment for a system for animal feed management, in accordance with an embodiment of the disclosure.

FIG. 2 is a detailed block diagram that illustrates an exemplary feed-management server for management of animal feed in a dairy farm, in accordance with an embodiment of the disclosure.

FIG. 3 is a detailed block diagram that illustrates an exemplary electronic device for management of animal feed in a dairy farm, in accordance with an embodiment of the disclosure.

FIGS. 4A, 4B, and 4C, collectively, illustrate an exemplary scenario for animal feed management in a dairy farm, in accordance with an embodiment of the disclosure.

FIG. 5 is a flowchart that illustrates first exemplary operations for animal feed management in a dairy farm, in accordance with an embodiment of the disclosure.

FIG. 6 is a flowchart that illustrates second exemplary operations for animal feed management in a dairy farm, in accordance with an embodiment of the disclosure.

### DETAILED DESCRIPTION

Various implementations may be found in a system and/or a method for animal feed management for a dairy farm. Exemplary aspects of the disclosure may comprise a system that may include one or more circuits in a feed-management server communicatively coupled to a plurality of sensing devices. The system may be configured to monitor activities of a plurality of entities in a defined area of a dairy farm by use of the plurality of sensing devices. The monitored activities may include at least a free-style grazing activity by a plurality of dairy animals included in the plurality of entities. The system may be configured to estimate an amount of milk yielded by each dairy animal of the plurality of dairy animals based on the monitored activities. The system may be further configured to determine a feed composition for each of the plurality of dairy animals, based on the determined amount of milk yielded by corresponding dairy animal and the monitored activities. The system may be further configured to control a loading device that loads a feed container with the determined feed composition for a first dairy animal to manage consumption of the feed composition by the first dairy animal. The feed container may be associated with the first dairy animal of the plurality of dairy animals.

In accordance with an embodiment, the plurality of sensing devices may include a wearable device associated with each of the plurality of care-takers. The plurality of sensing devices may further include a sensing tag associated with each of the plurality of dairy animals. The sensing tag may comprise an embedded camera. The monitored activities of the plurality of entities may further include activities of a plurality of care-takers, and activities of a plurality of off-springs of the plurality of dairy animals. In accordance with an embodiment, the monitored activities of the plurality of care-takers may correspond to a hand-based milking activity of the plurality of dairy animals by the plurality of care-takers. The system may further compute a wage parameter for the plurality of care-takers based on the monitored activities of the plurality of care-takers. The monitored activities of the plurality of off-springs may correspond to a milk consumption activity by the plurality of off-springs from udder of the plurality of dairy animals.

The system may be further configured to update the determined feed composition based on health information of the plurality of dairy animals received from the plurality of sensing devices associated with the plurality of dairy animals. The determined feed composition may be further updated based on a change in the determined amount of milk yielded by each dairy animal of the plurality of dairy animals or the monitored activities. The system may further determine an amount of feed of the determined feed composition for each of the plurality of dairy animals.

In accordance with an exemplary aspect of the disclosure, the system and/or the method for animal feed management may further include one or more circuits in an electronic device communicatively coupled to the feed-management server and a sensing device. The electronic device may be configured to identify a first dairy animal among the plurality of dairy animals based on a proximity to the sensing device associated with the first dairy animal. The electronic device may be further configured to determine a start time instant and a stop time instant of a hand-based milking activity for the first dairy animal, based on a set of gestures of a first care-taker recorded during the hand-based milking activity of the first dairy animal. The first care-taker may be associated with the electronic device. The electronic device may further determine an amount of milk yielded by the first dairy animal based on at least the determined start time instant and the stop time instant of the hand-based milking activity of the first dairy animal. The determination of the amount of milk yielded by the first dairy animal is further based on a free-style grazing activity by the first dairy animal in a grazing area and an amount of milk consumed from udder of the first dairy animal by one or more off-springs of the first dairy animal. The electronic device may further communicate the determined amount of milk yielded to the feed-management server. The feed-management server may then determine a feed composition for the first dairy animal based on the communicated amount of milk yielded. The feed-management server may be configured to control a loading device that loads a feed container, associated with the first dairy animal, with the determined feed composition to manage consumption of the feed composition by the first dairy animal.

In accordance with an embodiment, the electronic device may be configured to track the set of gestures of the first care-taker in an event the first care-taker performs the hand-based milking activity of the first dairy animal. The set of gestures of the first care-taker may be further tracked by the sensing device associated with the first dairy animal. The set of gestures of the first care-taker may be tracked in real time or near real time. The electronic device may further generate a notification to notify the first care-taker to discontinue the hand-based milking of the first dairy animal, based on a time duration of the hand-based milking activity that exceeds a defined milking duration threshold of the first dairy animal.

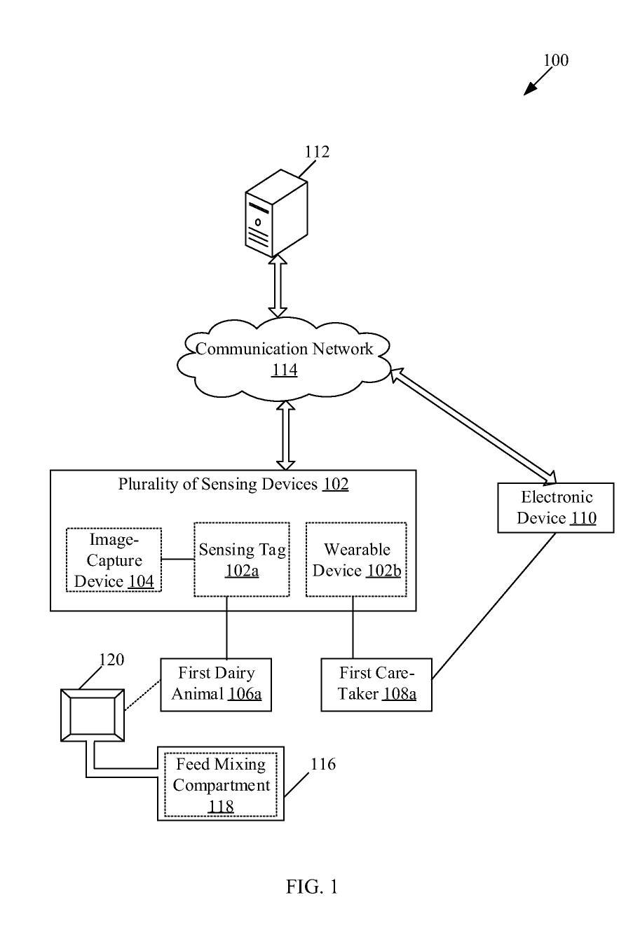

FIG. 1 is a block diagram that illustrates a network environment for a system for animal feed management, in accordance with an embodiment of the disclosure. With reference to FIG. 1, there is shown a network environment 100 of the animal feed management system. The network environment 100 may include a plurality of sensing devices 102. The plurality of sensing devices 102 may include a sensing tag 102a and a wearable device 102b. The sensing tag 102a may include an image-capture device 104 and may be associated with a first dairy animal 106a. The wearable device 102b may be associated with a first care-taker 108a. There is further shown an electronic device 110, a feed-management server 112, and a communication network 114. There is also shown a loading device 116 including a feed mixing compartment 118 and a feed container 120 related to the first dairy animal 106a. The electronic device 110 may be communicatively coupled with the wearable device 102b of the first care-taker 108a. The plurality of sensing devices 102, the electronic device 110, and the feed-management server 112 may be communicatively coupled with each other, via the communication network 114.

The plurality of sensing devices 102 may comprise suitable logic, circuitry, interfaces, and/or code that may be configured to track activities of a plurality of entities in a defined area of a dairy farm. The plurality of entities may include a plurality of dairy animals (such as the first dairy animal 106a) and a plurality of care-takers (such as the first care-taker 108a). The plurality of sensing devices 102 may be configured to transmit information pertaining to the tracked activities of the plurality of entities to the electronic device 110 and/or the feed-management server 112. The plurality of sensing devices 102 may comprise a plurality of sensing tags (such as the sensing tag 102a) and a plurality of wearable devices (such as the wearable device 102b).

The sensing tag 102a may comprise suitable logic, circuitry, interfaces, and/or code that may be configured to track the activities of a dairy animal (such as the first dairy animal 106a). The sensing tag 102a may be further configured to store identification information of a dairy animal (such as the first dairy animal 106a) of the plurality of dairy animals. The sensing tag 102a may be configured to determine health information of the first dairy animal 106a. The sensing tag 102a may be configured to store information pertaining to an amount of milk yielded by the first dairy animal 106a and the time-of-yield. The sensing tag 102a may be configured to transmit the determined health information of the first dairy animal 106a to the feed-management server 112. The sensing tag 102a may include the image-capture device 104. The sensing tag 102a may comprise a plurality of sensors, such as a radio frequency identification (RFID) sensor, a health monitoring sensor, a proximity sensor, an infra-red (IR) sensor, or a combination thereof, which may enable the sensing tag 102a to determine the health information of the first dairy animal 106a. The sensing tag 102a may be worn by an individual dairy animal to track activities of the individual dairy animal.

The wearable device 102b may comprise suitable logic, circuitry, interfaces, and/or code that may be configured to track activities of a care-taker (such as the first care-taker 108a) of the plurality of care-takers. The wearable device 102b may be configured to track a set of gestures of the first care-taker 108a. The wearable device 102b may be further configured to store information pertaining to an amount of milk collected by the first care-taker 108a from the plurality of dairy animals (such as the first dairy animal 106a). The wearable device 102b may be configured to detect a presence of a dairy animal (such as the first dairy animal 106a), based on the sensing tag 102a of the first dairy animal 106a that is within a defined proximity range of the wearable device 102b. The defined proximity range of the wearable device 102b may refer to a range of distance within which the wearable device 102b may communicate with other devices, such as the sensing tag 102a or the electronic device 110. The wearable device 102b may be configured to transmit information pertaining to the tracked activities of the first care-taker 108a to the electronic device 110 and/or the feed-management server 112. The wearable device 102b may comprise a plurality of sensors, such as a motion sensor, an accelerometer sensor, a gyroscope, a proximity sensor, an infra-red (IR) sensor, or a combination thereof, which may enable the wearable device 102b to track the activities of the first care-taker 108a. Examples of the wearable device 102b may include, but are not limited to, a smart band, a smart watch, a smart glass, and/or other wearable device.

The image-capture device 104 may comprise suitable logic, circuitry, interfaces, and/or code that may be configured to capture the one or more digital images and/or videos. Further, the image-capture device 104 may be configured to communicate the captured one or more digital images and/or videos, such as a color image, as input to the electronic device 110 and/or the feed-management server 112 for processing. The image-capture device 104 may include a lens assembly and an image sensor that may enable capture of the one or more digital images and/or videos. The image sensor of the image-capture device 104 may be implemented by use of a charge-coupled device (CCD) technology or complementary metal-oxide-semiconductor (CMOS) technology. Examples of the image-capture device 104 may include, but are not limited to, at least a camera, a camcorder, and an action cam. The image-capture device 104 may be implemented as an integrated unit of the sensing tag 102a or a separate device. For example, the image-capture device 104 may be positioned at various body portions, such as strapped around the neck portion of a dairy animal, or along the legs or lower portion of stomach, of a dairy animal, such as the first dairy animal 106a. However, it should readily be understood that the scope of the disclosure is not limited to the positioning of the image-capture device 104 around the neck portion or the legs or lower portion of stomach of the dairy animal. The image-capture device 104 may be positioned at other body portions of the dairy animal to focus at surrounding areas around the dairy animal and/or an udder portion of the dairy animal.

The first dairy animal 106a may refer to an animal that is capable of production of milk. The first dairy animal 106a, for example, may be a cow, a buffalo, a goat, or any other dairy animal that yields milk consumable by humans. The first dairy animal 106a may one of plurality of dairy animals. The first dairy animal 106a may be further associated with the sensing tag 102a. The amount of milk yielded by the first dairy animal 106a may be dependent on a feed intake of the first dairy animal 106a.

The first care-taker 108a may refer to a human, who may perform one or more activities for management of the dairy farm. The first care-taker 108a may be a farmer, a laborer, or any other person involved in the management of the dairy farm. The one or more activities performed by the first care-taker 108a may include a hand-based milking activity for the collection of milk from the plurality of dairy animals (such as the first dairy animal 106a). The one or more activities performed by the first care-taker 108a may further include a cleaning activity of the dairy farm and a collection of dairy-animal dung. A wage parameter of the first care-taker 108a may be determined based on the one or more activities performed by the first care-taker 108a. The wage parameter may refer to compensation and/or an incentive given to the first care-taker 108a in return for the one or more activities performed in the dairy farm.

The electronic device 110 may comprise suitable logic, circuitry, interfaces, and/or code that may be configured to determine an amount of milk yielded by an identified dairy animal (such as the first dairy animal 106a) of the plurality of dairy animals. The electronic device 110 may be associated with the first care-taker 108a. The electronic device 110 may generate a notification to notify the first care-taker 108a to discontinue a hand-based milking activity of the first dairy animal 106a, based on a time duration of the hand-based milking activity that exceeds a defined milking duration threshold of the first dairy animal 106a. The electronic device 110 may be communicatively coupled to the wearable device 102b associated with the first care-taker 108a and the feed-management server 112, via the communication network 114. Examples of the electronic device 110 may include, but are not limited to, a smartphone, a tablet computer, a computing device, a server, a computer work-station, a mainframe machine, and/or other electronic devices.

The feed-management server 112 may comprise suitable logic, circuitry, interfaces, and/or code that may be configured to determine a feed composition for each of the plurality of dairy animals (such as the first dairy animal 106a). The feed-management server 112 may determine different feed composition for different dairy animals of the plurality of dairy animals, based on an amount of milk yielded by each corresponding dairy animal of the plurality of dairy animals. The feed-management server 112 may be configured to monitor activities of the plurality of entities (such as the plurality of dairy animals and the plurality of care-takers) in a defined area of a dairy farm to estimate the amount of milk yielded by each of the plurality of dairy animals (such as the first dairy animal 106a). Examples of the feed-management server 112 may include, but are not limited to, an application server, a cloud server, a web server, a database server, a file server, a mainframe server, or a combination thereof.

The communication network 114 may include a medium through which the plurality of sensing devices 102 and the electronic device 110 may communicate with the feed-management server 112. Examples of the communication network 114 may include, but are not limited to, the Internet, a cloud network, a Long Term Evolution (LTE) network, a Wireless Local Area Network (WLAN), a Local Area Network (LAN), a telephone line (POTS), and/or a Metropolitan Area Network (MAN). Various devices in the network environment 100 may be configured to connect to the communication network 114, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11s, IEEE 802.11g, multi-hop communication, wireless access point (AP), device to device communication, cellular communication protocols, or Bluetooth (BT) communication protocols, or a combination thereof.

In operation, the feed-management server 112 may be configured to monitor the activities of a plurality of entities in a defined area of a dairy farm. The plurality of entities may include the plurality of dairy animals (such as the first dairy animal 106a) and the plurality of care-takers (such as the first care-taker 108a). The plurality of entities may further include a plurality of off-springs of the plurality of dairy animals. The plurality of off-springs may refer to the young ones (for example cow calves) of the plurality of dairy animals. The feed-management server 112 may monitor the activities of the plurality of entities by use of the plurality of sensing devices 102.

The activities of the plurality of entities may include a free-style grazing activity by the plurality of dairy animals included in the plurality of entities. The activities of the plurality of entities may further include activities of the plurality of care-takers and activities of the plurality of off-springs of the plurality of dairy animals. Examples of the activities of the plurality of care-takers may include, but are not limited to, a hand-based milking activity of the plurality of dairy animals by the plurality of care-takers and a dairy farm cleaning activity. An example of the activities of the plurality of off-springs of the plurality of dairy animals may include, but are not limited to, a milk consumption activity by the plurality of off-springs from udder of the plurality of dairy animals. For the sake of brevity, the monitoring of activities of the plurality of entities by the feed-management server 112 has been explained with reference to the first dairy animal 106a and the first care-taker 108a. However, it should readily be understood that the scope of the disclosure is not limited to the monitoring of activities of the first dairy animal 106a and the first care-taker 108a.

The plurality of sensing devices 102 may be configured to track the activities of the plurality of entities based on instructions received from the feed-management server 112. The plurality of sensing devices 102 may include the sensing tag 102a and the wearable device 102b. The sensing tag 102a, associated with the first dairy animal 106a, may track the activities of the first dairy animal 106a based on the instructions received from the feed-management server 112. The sensing tag 102a may instruct the image-capture device 104 to capture one or more digital images and/or videos of the one or more activities of the first dairy animal 106a. For example, the first dairy animal 106a may graze grass in a grazing area, which is referred to as a free-style grazing activity. The image-capture device 104 of the sensing tag 102a may capture one or more digital images and/or videos during the free-style grazing activity by the first dairy animal 106a. The image-capture device 104 may continuously capture one or more digital images and/or videos of the one or more activities of the first dairy animal 106a after a defined interval of time. For example, the image-capture device 104 may capture the one or more digital images and/or videos of the one or more activities of the first dairy animal 106a after every “20 seconds.” The image-capture device 104 may further associate a timestamp with each of the captured one or more digital images and/or videos. The timestamp associated with each of the captured one or more digital images may represent a time instant at which the corresponding digital image was captured by the image-capture device 104. Alternatively stated, the timestamp associated with each of the captured one or more digital images and/or videos may represent a time instant of the occurrence an activity depicted by the corresponding digital image. For example, a captured digital image, that depicts a free-grazing activity by the first dairy animal 106a, is associated with a timestamp “10:34:22 a.m.” In this scenario, the timestamp “10:34:22 a.m.” may represent the time instant of the occurrence of the free-grazing activity by the first dairy animal 106a. The captured one or more digital images and/or videos may be transmitted to the feed-management server 112 by the sensing tag 102a.

The feed-management server 112 may further monitor the activities of the first dairy animal 106a based on the one or more digital images and/or videos received from the sensing tag 102a. The feed-management server 112 may use the timestamp associated with each of the received one or more digital images and/or videos to monitor the activities of the first dairy animal 106a. For example, the feed-management server 112 may process the received one or more digital images to identify the digital images that depict the free-style grazing activity by the first dairy animal 106a. The feed-management server 112 may further arrange the identified digital images related to the free-style grazing activity by the first dairy animal 106a in a chronological order. The timestamp of the first digital image in the arranged digital images may represent a start time instant of the free-style grazing activity by the first dairy animal 106a and the last digital image in the arranged digital images may represent a stop time instant of the free-style grazing activity by the first dairy animal 106a. Thus, based on the start time instant and the stop time instant, the feed-management server 112 may determine a time duration for which the first dairy animal 106a was engaged in the free-style grazing activity. The feed-management server 112 may monitor the other activities performed by the first dairy animal 106a similar to the monitoring of the free-style grazing activity.

The wearable device 102b may be configured to track the activities of the first care-taker 108a based on the instructions received from the feed-management server 112. The wearable device 102b may be worn by the first care-taker 108a. For example, the wearable device 102b may be worn in the hand of the first care-taker 108a. The wearable device 102b may be configured to track a set of gestures of the first care-taker 108a. The tracked set of gestures may represent the activities performed by the first care-taker 108a. For example, the wearable device 102b may track hand gestures of the first care-taker 108a. The tracking of hand gestures may include, but is not limited to, a determination of a speed of movement of the hands, a direction of the movement of the hands, a time duration for which the first care-taker 108a repeats a same hand gesture, and a timestamp associated with each hand gestures. The wearable device 102b may be further configured to detect a presence of the sensing tag 102a, based on the sensing tag 102a that is in the defined proximity range of the wearable device 102b. Alternatively stated, the wearable device 102b may detect the presence of the first dairy animal 106a, based on the sensing tag 102a associated with the first dairy animal 106a that is in the defined proximity range of the wearable device 102b. The wearable device 102b may transmit the information pertaining to the tracked set of gestures and the detected presence of the first dairy animal 106a to the feed-management server 112. Alternatively, the wearable device 102b may transmit the information pertaining to the tracked set of gestures to the electronic device 110. For example, the wearable device 102b may transmit accelerometer sensor's signal variations to the electronic device 110

The feed-management server 112 may monitor the activities of the first care-taker 108a based on the information pertaining to the tracked set of gestures, received from the wearable device 102b and/or the electronic device 110. The feed-management server 112 may determine a start time and a stop time of an activity performed by the first care-taker 108a based on the tracked set of gestures of the first care-taker 108a. For example, the feed-management server 112 may determine that the wearable device 102b associated with the first care-taker 108a is in the proximity of the sensing tag 102a associated with the first dairy animal 106a, based on the information received from the wearable device 102b. The feed-management server 112 may further determine that the first care-taker 108a performed a hand-based milking activity based on the hand gesture information (such as the accelerometer sensor's signal variations) received from the wearable device 102b. Thus, the feed-management server 112 may determine that the first care-taker 108a performed the hand-based milking activity on the first dairy animal 106a that is in the proximity of the wearable device 102b. The feed-management server 112 may further determine a time duration associated with the hand-based milking activity performed by the first care-taker 108a based on information pertaining to the timestamp associated with each hand gestures. The feed-management server 112 may further determine a time duration of other activities performed by the first care-taker 108a similar to hand-based milking activity as described.

The feed-management server 112 may be further configured to estimate an amount of milk yielded by the first dairy animal 106a based on the monitored activities. The amount of milk yielded by the first dairy animal 106a may depend on the determined time duration associated with the hand-based milking activity of the first dairy animal 106a performed by the first care-taker 108a. The amount of milk yielded by the first dairy animal 106a may further depend on a milking capacity of the first care-taker 108a as determined based on the tracked set of gestures of the first care-taker 108a. For example, the feed-management server 112 may determine that the first care-taker 108a collects “0.5 liters” of milk from the first dairy animal 106a in “15 minutes” based on the tracked set of gestures of the first care-taker 108a. The feed-management server 112 may further determine that the first care-taker 108a performs hand-based milking activity of the first dairy animal 106a for “45 minutes” based on the received information from the wearable device 102b. In this scenario, the feed-management server 112 may estimate the amount of milk yielded by the first dairy animal 106a to be “1.5 liters”. The information pertaining to the amount of milk collected by the first care-taker 108a may be stored in local memory of the wearable device 102b. The amount of milk yielded by the first dairy animal 106a may be stored in local memory of the sensing tag 102a.

The feed-management server 112 may be further configured to determine a feed composition for the first dairy animal 106a, based on the determined amount of milk yielded by the first dairy animal 106a and the monitored activities. The feed composition may refer to one or more ingredients that constitute the feed for the first dairy animal 106a. Usually, the feed for a dairy animal may depend on the body weight of the dairy animal. For example, the feed for a dairy animal may be “2.5%” to “3.5%” of the body weight of the dairy animal. Thus, a cow weighing “1000 kg” requires “25 kg” of feed per day. The feed composition may include a fixed ratio of dry feed and green or wet feed. For example, the feed composition may include “40%” dry feed and “60%” green or wet feed. The feed composition may also depend on the amount of milk yielded by a dairy animal. For example, for a milk yield of “1 liter” from a cow, the feed composition may include “500 g” of balanced cattle feed, “100 g” of mineral mixture, and “10 liters” of water. The feed-management server 112 may then determine the feed composition for the first dairy animal 106a. A person with ordinary skill in the art will understand that the abovementioned example is for illustrative purpose and should not be construed to limit the scope of the disclosure.

The determination of the feed composition for the first dairy animal 106a may be further dependent on the time duration for which the first dairy animal 106a was engaged in the free-style grazing activity. The feed-management server 112 may determine an intake of food by the first dairy animal 106a during the free-style grazing activity based on the time duration for which the first dairy animal 106a was engaged in the free-style grazing activity. The intake of food may be determined based on an average intake of food during free-style grazing by the first dairy animal 106a in defined time duration. For example, the feed-management server 112 may determine that the first dairy animal 106a was engaged in the free-style grazing activity for “30 minutes”. The feed-management server 112 further determines that the average intake of food during free-style grazing by the first dairy animal 106a in “10 minutes” is 100 g of green feed and “50 g” dry feed. The feed-management server 112 may then determine that the intake of food by the first dairy animal 106a during the free-style grazing activity is “300 g” of green feed and “150 g” of dry feed. The determination of the feed-management server 112 may be based on the monitoring of the activities of the first dairy animal 106a by use of the image-capture device 104.

The feed-management server 112 may then determine the feed composition for the first dairy animal 106a based on the determined intake of food during the free-style grazing activity. For example, based on the last amount of milk yielded (such as “1.5 liters”) by the first dairy animal 106a, the feed-management server 112 may determine the feed composition for the first dairy animal 106a. The feed-management server 112 may further reduce the determined feed composition by the amount of food intake by the first dairy animal 106a during the free-style grazing activity by the first dairy animal 106a.

The feed-management server 112 may be further configured to control the loading device 116 that may load the feed container 120, associated with the first dairy animal 106a, with the determined feed composition. The feed-management server 112 may load the feed container 120 with the determined feed composition for the first dairy animal 106a to manage consumption of the feed composition by the first dairy animal 106a. The loading device 116 may refer to a device where the feed of the determined feed composition is prepared. The loading device 116 may comprise one or more feed mixing compartments (such as the feed mixing compartment 118). The one or more ingredients of the feed corresponding to the first dairy animal 106a are mixed in accordance with the determined feed composition in the feed mixing compartment 118 that is related to the first dairy animal 106a. The inflow of each of the one or more ingredients in the loading device 116 may be controlled by use of one or more valves. Each of the one or more valves may remain open until the corresponding ingredient is filled in the feed mixing compartment 118 of the loading device 116 in accordance with the determined feed composition. For example, the determined feed composition may include “80 g” of mineral mixture. The valve of the mineral mixture may thus remain open until “80 g” of the mineral mixture is filled in the feed mixing compartment 118 of the loading device 116. The feed-management server 112 may control the operations of the one or more valves. The loading device 116 may then load the feed container 120 associated with the first dairy animal 106a with the determined feed composition contained in the feed mixing compartment 118. The first dairy animal 106a may then consume the determined feed from the feed container 120. The feed-management server 112 may be further configured to determine the feed composition for each of the plurality of dairy animals as determined for the first dairy animal 106a.

In accordance with an embodiment, the sensing tag 102a may be further configured to determine health information of the first dairy animal 106a. The health information may include one or more health parameters of the first dairy animal 106a. Examples of the one or more health parameters, may include, but are not limited to, blood count, body temperature, respiration rate, heart beat rate, and/or a combination thereof. The sensing tag 102a may further transmit the statistics of health information of the first dairy animal 106a to the feed-management server 112. The feed-management server 112 in return may update the determined feed composition based on an anomaly that is detected in the health information of the first dairy animal 106a. The feed-management server 112 may add one or more medicinal ingredients in the determined feed composition to treat the detected anomaly. For example, the feed-management server 112 may detect an increment in body temperature of the first dairy animal 106a, based on the health information received from the sensing tag 102a. The feed-management server 112 may add a medicinal ingredient (such as an antibiotic) required to treat the increased body temperature. In accordance with an embodiment, the feed-management server 112 may be further configured to transmit the health information of the first dairy animal 106a to a computing device (not shown) of a health analyst, in real time. The health analyst may further prescribe one or more medicinal ingredients to be added to the determined feed composition of the first dairy animal 106a by use of the computing device. The feed-management server 112 may further add the one or more medicinal ingredients prescribed by the health analyst. In accordance with an embodiment, the feed-management server 112 may further update the feed composition based on one or more external parameters, such as temperature conditions, weather conditions, or one or more guidelines by various health agencies.

In accordance with an embodiment, the image-capture device 104 may be further configured to track an activity of the plurality of off-springs of the first dairy animal 106a. The activity of the plurality of off-springs may correspond to a milk consumption activity of the plurality of off-springs from the udder portion of the first dairy animal 106a. Usually, an off-spring of a dairy animal is made to consume a certain amount of milk from the udder portion of the parent dairy animal (such as the first dairy animal 106a). The amount of milk consumed by the off-spring further accounts to the milk yielded by parent dairy animal (such as the first dairy animal 106a). Alternatively stated, the amount of milk yielded by the first dairy animal 106a is a sum of the amount of milk collected by the first care-taker 108a at the time of the hand-based milking activity for the first dairy animal 106a and the amount of milk consumed by the plurality of off-springs from the udder portion of the first dairy animal 106a.

In accordance with an embodiment, the image-capture device 104 may be focused at the udder portion of the first dairy animal 106a. The image-capture device 104 may capture one or more digital images and/or videos depicting the milk consumption activity of the plurality of off-springs from the udder portion of the first dairy animal 106a. The sensing tag 102a may further transmit the captured one or more digital images and/or videos to the feed-management server 112. The feed-management server 112 may further monitor the milk consumption activity of the plurality of off-springs based on the received one or more digital images and/or videos. The feed-management server 112 may identify a start time instant and a stop time instant for the milk consumption activity as determined for the free-style grazing activity by the first dairy animal 106a. The feed-management server 112 may further determine the time duration for which the plurality of off-springs consume milk from the udder portion of the first dairy animal 106a. The feed-management server 112 may then be configured to determine the amount of milk consumed by the plurality of off-springs based on the time duration for which the plurality of off-springs consume milk and a capacity of milk consumption associated with each of the plurality of off-springs. For example, an off-spring, with a capacity to consume “0.5 liters” of milk in “20 minutes”, consumes milk for “40 minutes” from the first dairy animal 106a. The feed-management server 112 may determine the amount of milk consumed by the off-spring to be “1 liter” based on the time duration (i.e., “40 minutes”) for which the off-spring consumes milk and the capacity of milk consumption (i.e., “0.5 liters” of milk consumption in “20 minutes”) associated with the off-spring. The determined amount of milk consumed by the plurality of off-springs further accounts to the milk yielded by the first dairy animal 106a.

In accordance with an embodiment, the feed-management server 112 may further monitor the hand-based milking activity performed by the first care-taker 108a, by use of the image-capture device 104, focused at the udder portion of the first dairy animal 106a. The image-capture device 104 may track the set of gestures of the first care-taker 108a by capture of one or more digital images and/or videos. The feed-management server 112 may use the captured one or more digital images and/or videos to monitor the hand-based milking activity performed by the first care-taker 108a based on hand movement tracking in the captured one or more digital images and/or videos.

In accordance with an embodiment, the feed-management server 112 may be further configured to determine a wage parameter for each of the plurality of care-takers based on the monitored activities of each of the plurality of care-takers. For example, the feed-management server 112 may retrieve information, pertaining to the amount of milk collected by the first care-taker 108a from the plurality of dairy animals, from the wearable device 102b. The feed-management server 112 may further determine a time duration spent by the first care-taker 108a to perform the one or more activities (such as the cleaning of the dairy farm, the collection of dairy-animal dung, the cleaning of the plurality of dairy animals) based on the information received from the sensing tag 102a and the wearable device 102b. The feed-management server 112 may then determine the wage parameter for the first care-taker 108a based on the time duration spent by the first care-taker 108a to perform the one or more activities.

In accordance with an embodiment, the electronic device 110 may identify the first dairy animal 106a among the plurality of dairy animals based on a proximity of the wearable device 102b to a sensing tag, such as the sensing tag 102a associated with said first dairy animal 106a. The proximity of the wearable device 102b to a sensing tag, such as the sensing tag 102a, may be determined based on a signal strength between the wearable device 102b and the sensing tag 102a. For example, the wearable device 102b may transmit the signal strength information of the wearable device 102b with sensing tags of the plurality of dairy animals to the electronic device 110. The electronic device 110 may identify a sensing tag, such as the sensing tag 102a, which has the strongest signal strength with the wearable device 102b. The electronic device 110 may further identify the dairy animal, such as the first dairy animal 106a, associated with the identified sensing tag 102a. The first dairy animal 106a may correspond to the dairy animal which is to be milked by the first care-taker 108a associated with the wearable device 102b. The electronic device 110 may present the information of the identified first dairy animal 106a, which is to be milked to the first care-taker 108a.

The electronic device 110 may be further configured to determine the start time instant and the stop time instant of the hand-based milking activity for the first dairy animal 106a based on the set of gestures of the first care-taker 108a recorded by the wearable device 102b during the hand-based milking activity of the first dairy animal 106a. The electronic device 110 may further determine the amount of milk yielded by the first dairy animal 106a based on the determined start time instant and the stop time instant of the hand-based milking activity of the first dairy animal 106a. The electronic device 110 may be further configured to transmit the determined amount of milk yielded by the first dairy animal 106a to the feed-management server 112 for the determination of the feed composition.

In accordance with an embodiment, the electronic device 110 may be further configured to generate a notification to notify the first care-taker 108a to discontinue the hand-based milking of the first dairy animal 106a. The electronic device 110 may generate the notification based on a time duration of the hand-based milking activity exceeding a defined milking duration threshold of the first dairy animal 106a. The milking duration threshold of the first dairy animal 106a may be defined based on a milking capacity of the first care-taker 108a and a milk yield capacity of the first dairy animal 106a. The milking capacity of a care-taker may refer to an amount of milk collected by the care-taker in an hour. The milk yield capacity of a dairy animal may refer to an average amount of milk yielded by dairy animal in a day. For example, the milking capacity of the first care-taker 108a is “4 liters” and the milk yield capacity of the first dairy animal 106a is “8 liters”. Thus, the milking duration threshold of the first dairy animal 106a may be defined as “2 hours”. The electronic device 110 may thus generate the notification to notify the first care-taker 108a to discontinue the hand-based milking of the first dairy animal 106a after “2 hours” of the hand-based milking of the first dairy animal 106a. In another exemplary scenario, an off-spring of the first dairy animal 106a may require “4 liters” of milk consumption in a day. In this scenario, the milk duration threshold of the first dairy animal 106a may be defined as “1 hour.” The electronic device 110 may thus generate the notification to notify the first care-taker 108a to discontinue the hand-based milking of the first dairy animal 106a after “1 hour” of the hand-based milking of the first dairy animal 106a.

In accordance with an embodiment, the feed-management server 112 may store information pertaining to milking capacity of each of the plurality of care-takers, average milk yield capacity of each of the plurality of dairy animals, and milk consumption capacity of each of the plurality of off-springs. The feed-management server 112 may be trained based on training data to determine the milking capacity of each of the plurality of care-takers, the average milk yield capacity of each of the plurality of dairy animals, and the milk consumption capacity of each of the plurality of off-springs.

The training data for training the feed-management server 112 to determine the milking capacity of a care-taker (such as the first care-taker 108a) may include an amount of milk collected by the first care-taker 108a and a time duration of the hand-based milking activity performed by the first care-taker 108a to collect the amount of milk. The amount of milk collected may be determined based on the tracked set of gestures. The time duration of the hand-based milking activity performed by the first care-taker 108a may be automatically determined by the feed-management server 112 based on the information of the set of gestures of the first care-taker 108a received from the wearable device 102b and/or the electronic device 110. Alternatively, the amount of milk collected may be fed manually by the first care-taker 108a by use of the electronic device 110. In accordance with an embodiment, the first care-taker 108a may use a specific application installed in the electronic device 110 to manually feed the information of the amount of milk collected.

The training data for training the feed-management server 112 to determine the average milk yield capacity of each of the plurality of dairy animals may include an amount of milk yielded by the corresponding dairy animal over a defined period of time. The training data for training the feed-management server 112 to determine the milk consumption capacity of each of the plurality of off-springs may include an amount of milk consumed by the corresponding off-spring from a feeder bottle and the time required for the milk consumption activity from the feeder bottle. The feeder bottle may refer to a means of feeding an off-spring of a dairy animal. The feeder bottle may resemble the udder portion of the dairy animal. For example, the first care-taker 108a may feed an off-spring of the first dairy animal 106a by use of a feeder bottle. The first care-taker 108a may manually determine the amount of milk consumed by off-spring from the feeder bottle and the time duration of the milk consumption activity from the feeder bottle. The first care-taker 108a may transmit the training data (i.e., the determined amount of milk consumed by the off-spring from the feeder bottle and the time duration of the milk consumption activity from the feeder bottle) to the feed-management server 112 by use of the specific application installed in the electronic device 110.

In accordance with an embodiment, the feed-management server 112 may be further configured to determine an amount of bio-waste collected from the dairy farm and a level of cleanliness of the dairy farm. The feed-management server 112 may determine the amount of bio-waste collected from the dairy farm and the level of cleanliness based on the monitored activities of the plurality of care-takers (such as the first care-taker 108a) and the one or more images and/or videos received form the image-capture device 104.

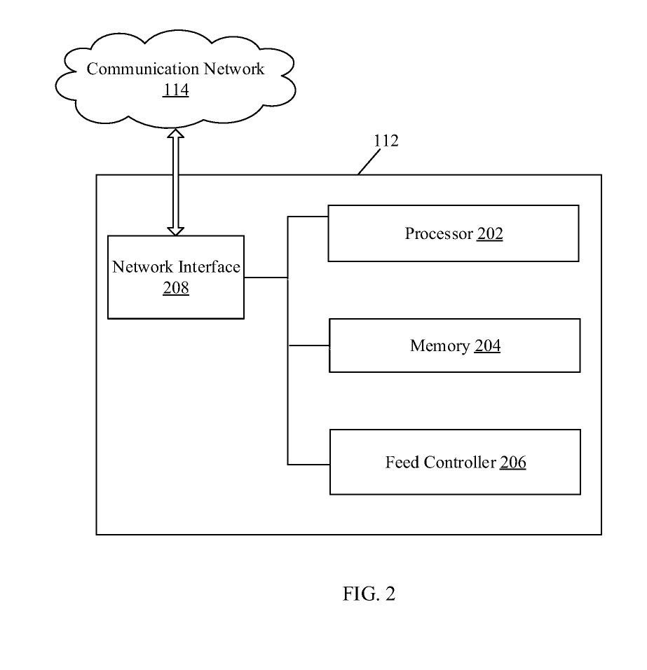

FIG. 2 is a detailed block diagram that illustrates an exemplary feed-management server for management of animal feed in a dairy farm, in accordance with an embodiment of the disclosure. FIG. 2 is explained in conjunction with elements from FIG. 1. With reference to FIG. 2, the exemplary feed-management server (such as the feed-management server 112) may comprise one or more circuits, such as a processor 202, a memory 204, a feed controller 206, and a network interface 208. The memory 204, the feed controller 206, and the network interface 208 may be communicatively connected to the processor 202. The feed-management server 112 may correspond to the animal feed management system.

The processor 202 may comprise suitable logic, circuitry, interfaces, and/or code that may be configured to execute a set of instructions stored in the memory 204. The processor 202 may be configured to instruct the feed controller 206 to manage feed of a plurality of dairy animals, such as the first dairy animal 106a. Other examples of the processor 202 may be an Application-Specific Integrated Circuit (ASIC) processor, a Complex Instruction Set Computing (CISC) processor, and/or other hardware processors.

The memory 204 may comprise suitable logic, circuitry, and/or interfaces that may be configured to store a set of instructions executable by the processor 202 and the feed controller 206. The memory 204 may be configured to store information of a plurality of activities for a plurality of entities (such as a plurality of dairy animals that includes the first dairy animal 106a (FIG. 1) and a plurality of care-takers that includes the first care-taker 108a (FIG. 1)). Examples of implementation of the memory 204 may include, but are not limited to, Random Access Memory (RAM), Read Only Memory (ROM), Hard Disk Drive (HDD), a flash memory, processor cache, and/or related storage electronic devices.

The feed controller 206 may comprise suitable logic, circuitry, interfaces, and/or code that may be configured to manage the feed of the plurality of dairy animals (such as the first dairy animal 106a). The feed controller 206 may be a specialized processor or circuitry configured to manage the feed of the plurality of dairy animals. For example, the feed controller 206 may be configured to monitor activities of the plurality of entities in a defined area of a dairy farm by use of the plurality of sensing devices 102 (FIG. 1). The feed controller 206 may be further configured to estimate an amount of milk yielded by each of the plurality of dairy animals included in the plurality of entities. The feed controller 206 may further determine a feed composition for each of said plurality of dairy animals and manage consumption of the feed composition by each dairy animal (such as the first dairy animal 106a) of the plurality of dairy animals. The feed controller 206 may manage the consumption of the feed composition by control of the loading device 116 that loads a feed container (such as the feed container 120) with the determined feed composition for the corresponding dairy animal. The feed controller 206 may be implemented as a separate special-purpose processor or circuitry in the feed-management server 112. Alternatively, the feed controller 206 and the processor 202 may be implemented as an integrated processor or a cluster of processors that perform the functions of the feed controller 206 and the processor 202. The feed controller 206 may be implemented, for example, on an ASIC or Field Programmable Gate Array (FPGA). Alternatively, the feed controller 206 may be implemented as a set of specialized instructions stored in the memory 204, which upon execution may perform the functions and operations for the feed-management server 112.

The network interface 208 may comprise suitable logic, circuitry, interfaces, and/or code that may be configured to establish communication between the feed-management server 112, the plurality of sensing devices 102, and the electronic device 110, via the communication network 114. The network interface 208 may be implemented by use of various known technologies to support wired or wireless communication of the feed-management server 112 with the communication network 114. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), Wi-MAX, a protocol for email, instant messaging, Short Message Service (SMS), Internet of Things (IoT), and/or variants thereof.

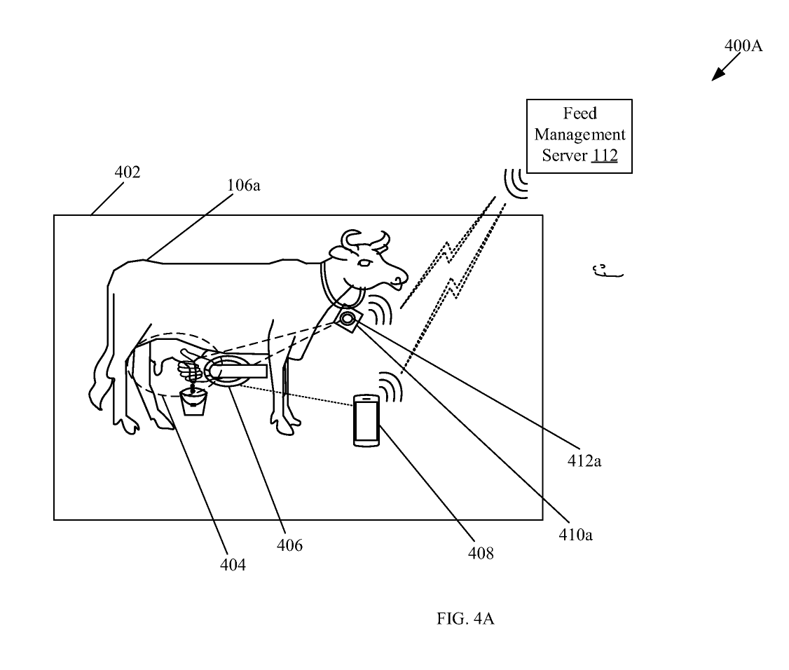

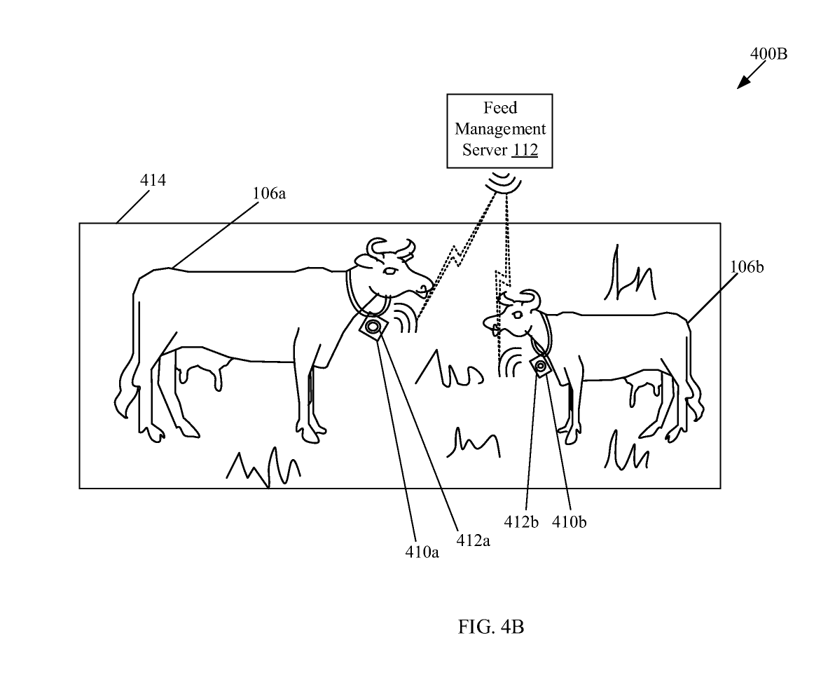

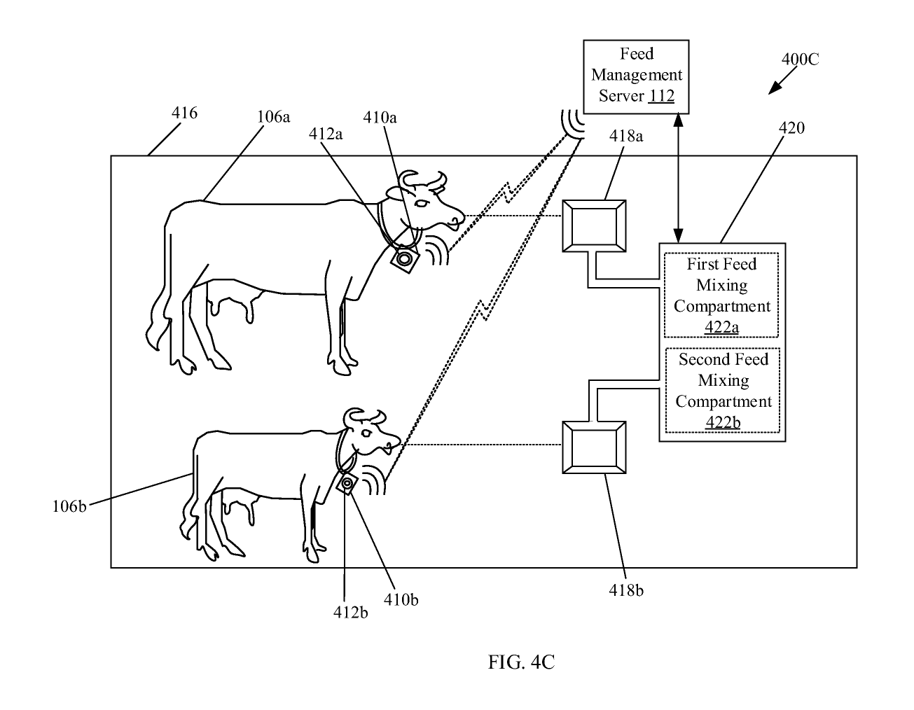

The functions and/or operations performed by the feed-management server 112, as described in FIG. 1, may be performed by the processor 202 and/or the feed controller 206. Other operations performed by the processor 202 and the feed controller 206 are further described in details in FIGS. 4A, 4B and 4C.

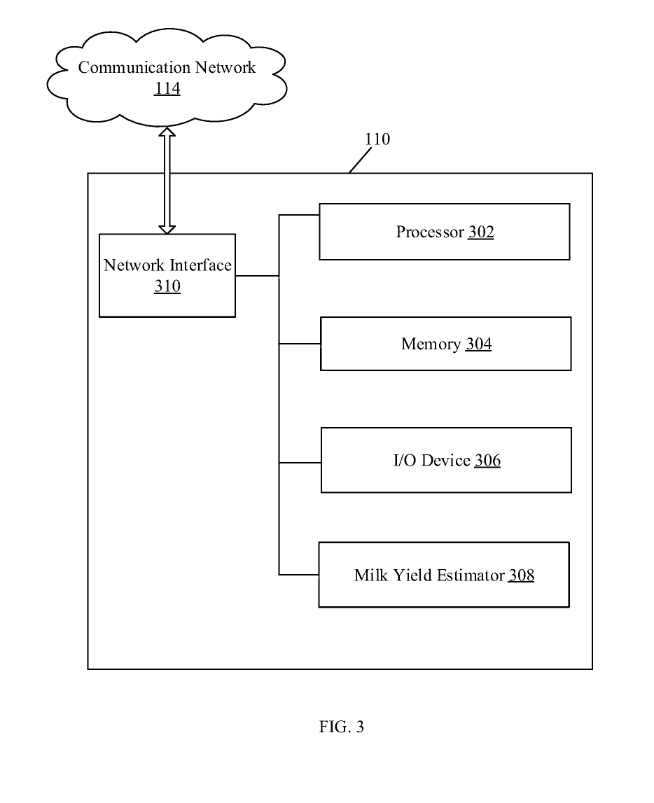

FIG. 3 is a detailed block diagram that illustrates an exemplary electronic device for management of animal feed in a dairy farm, in accordance with an embodiment of the disclosure. FIG. 3 is explained in conjunction with elements from FIGS. 1 and 2. With reference to FIG. 3, the exemplary electronic device (such as the electronic device 110) may comprise one or more circuits, such as a processor 302, a memory 304, an input/output (I/O) device 306, a milk yield estimator 308, and a network interface 310. The memory 304, the I/O device 306, the milk yield estimator 308, and the network interface 310 may be communicatively connected to the processor 302.

The processor 302 may comprise suitable logic, circuitry, interfaces, and/or code that may be configured to execute a set of instructions stored in the memory 304. The processor 302 may be configured to instruct the milk yield estimator 308 to determine an amount of milk yielded by a dairy animal (such as the first dairy animal 106a) of the plurality of dairy animals. The processor 302 may be configured to identify a dairy animal (such as the first dairy animal 106a) among the plurality of dairy animals based on a proximity of the electronic device 110 or the wearable device 102b to the sensing tag 102a associated with the dairy animal (such as the first dairy animal 106a). Other examples of the processor 302 may be an ASIC processor, a Complex Instruction Set Computing (CISC) processor, and/or other hardware processors.

The memory 304 may comprise suitable logic, circuitry, and/or interfaces that may be operable to store a set of instructions executable by the processor 302 and the milk yield estimator 308. The memory 304 may be configured to store information of a set of gestures of a care-taker (such as the first care-taker 108a), associated with the electronic device 110, during a hand-based milking activity of a dairy animal (such as the first dairy animal 106a). Examples of implementation of the memory 304 may include, but are not limited to, RAM, ROM, HDD, and/or a flash memory (such as an SD card, Micro SD card, and/or the like).

The I/O device 306 may comprise suitable logic, circuitry, interfaces, and/or code that may be configured to receive an input from a user, such as the first care-taker 108a. The I/O device 306 may be further configured to provide an output to the first care-taker 108a. The I/O device 306 may comprise various input and output devices, which may be configured to communicate with the processor 302. Examples of the input devices may include, but are not limited to, a touch screen, a keyboard, a mouse, a joystick, and/or a microphone. Examples of the output devices may include, but not limited to, a display screen and/or a speaker.

The milk yield estimator 308 may comprise suitable logic, circuitry, interfaces, and/or code that may be configured to determine an amount of milk yielded by the identified dairy animal (such as the first dairy animal 106a). The milk yield estimator 308 may be configured to determine a start time instant and a stop time instant of a hand-based milking activity for the first dairy animal 106a by the first care-taker 108a to determine the amount of milk yielded by the first dairy animal 106a. The start time instant and the stop time instant of the hand-based milking activity for the first dairy animal 106a may be determined based on a set of gestures of the first care-taker 108a. The milk yield estimator 308 may be further configured to track the set of gestures of the first care-taker 108a based on the first care-taker 108a who performs the hand-based milking activity of the first dairy animal 106a. The milk yield estimator 308 may be implemented as a separate special-purpose coprocessor or circuitry in the electronic device 110. Alternatively, the milk yield estimator 308 and the processor 302 may be implemented as an integrated processor or a cluster of processors that perform the functions of the milk yield estimator 308 and the processor 302. The milk yield estimator 308 may be implemented as a set of specialized instructions stored in the memory 204, which upon execution may perform the functions and operations for the electronic device 110.

The network interface 310 may comprise suitable logic, circuitry, interfaces, and/or code that may be configured to establish communication between the electronic device 110, the plurality of sensing devices 102, and the feed-management server 112, via the communication network 114. The network interface 310 may be implemented by use of various known technologies to support wired or wireless communication of the electronic device 110 with the communication network 114. The network interface 310 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 310 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), Wi-MAX, a protocol for email, instant messaging, and/or Short Message Service (SMS).

The functions and/or operations performed by the electronic device 110, as described in FIG. 1, may be performed by the processor 302, and/or the milk yield estimator 308. Other operations performed by the processor 302 and the milk yield estimator 308 are further described in details in FIGS. 4A, 4B, and 4C.

FIGS. 4A, 4B, and 4C, collectively, illustrate an exemplary scenario for animal feed management in a dairy farm, in accordance with an embodiment of the disclosure. FIGS. 4A, 4B, and 4C are described in conjunction with elements from FIGS. 1, 2, and 3. With reference to FIG. 4A, there is shown a first example 400A of animal feed management in a dairy farm. With reference to the first example 400A, there is further shown the first dairy animal 106a in a first defined area 402. There is further shown an udder portion 404 of the first dairy animal 106a, a wearable device 406 and a smartphone 408 associated with the first care-taker 108a. There is also shown a first sensing tag 410a with a first image-capture device 412a associated with the first dairy animal 106a and the feed-management server 112. The feed-management server 112 may be communicatively coupled to the smartphone 408 and the first sensing tag 410a, via the communication network 114. The first defined area 402 may correspond to a milking area of a dairy farm.

In accordance with the first example 400A, the processor 202 may be configured to monitor the activities of the first dairy animal 106a and the first care-taker 108a in the first defined area 402 by use of the wearable device 406 and the first sensing tag 410a. The wearable device 406 may be worn in the hand of the first care-taker 108a. The wearable device 406 may further correspond to the wearable device 102b (FIG. 1) of the plurality of sensing devices 102. The wearable device 406 may be may be communicatively coupled to the smartphone 408 of the first care-taker 108a. The smartphone 408 may correspond to the electronic device 110 (FIG. 1). The first sensing tag 410a may correspond to the sensing tag 102a (FIG. 1). The first sensing tag 410a may be worn by the first dairy animal 106a, for example, in the neck portion, as shown. The first sensing tag 410a may be embedded with the first image-capture device 412a. The first sensing tag 410a may correspond to the sensing tag 102a and the first image-capture device 412a may correspond to the image-capture device 104. The processor 202 may transmit instructions to the smartphone 408 and/or the first sensing tag 410a to track the activities of the first dairy animal 106a and the first care-taker 108a.

The wearable device 406 may include, and/or may be communicatively coupled to one or more sensors that may track the activities of the first care-taker 108a. The wearable device 406 may be configured to detect a presence of the first sensing tag 410a, based on the first sensing tag 410a that is in the proximity range of the wearable device 406. The wearable device 406 may further transmit the information pertaining to the detected presence of the first sensing tag 410a to the processor 302, via a short range communication of the communication network 114.

The processor 202 may further identify the first dairy animal 106a based on the received information from the electronic device 110 or the wearable device 406. The processor 202 may further instruct the first sensing tag 410a to focus the first image-capture device 412a to the udder portion 404 of the first dairy animal 106a for tracking the hand-based milking activity performed by the first care-taker 108a. The first care-taker 108a may start to perform the hand-based milking activity at the udder portion 404 of the first dairy animal 106a to collect milk.

The wearable device 406 and the first image-capture device 412a may track the body posture, and set of gestures, actions, and/or motion of the first care-taker 108a. The set of gestures, actions, and/or motion may include, for example, a movement of limbs such as hands and/or arms during hand-based milking activity at the udder portion 404 of the first dairy animal 106a. The first care-taker 108a may move the limbs such as the hands and arms in a defined manner, so as to collect a maximum possible amount of milk. The wearable device 406 may detect signal variations due to the movement of limbs such as hands and arms of the first care-taker 108a while the first care-taker 108a performs the hand based milking activity. The wearable device 406 may further transmit the detected signal variations to the processor 302. The first image-capture device 412a may further capture the digital images and/or videos of the first care-taker 108a, while first care-taker 108a performs the hand based milking activity of the first dairy animal 106a. The first image-capture device 412a may capture the digital images and/or video in real time or near real time. The first image-capture device 412a may further communicate the captured digital images and/or videos to the processor 202 and/or the processor 302.

The processor 202 may be further configured to monitor the activities (such as the hand-based milking activity) of the first care-taker 108a based on the received information pertaining to set of gestures of the first care-taker 108a and/or the received captured digital images and/or videos. The processor 202 may monitor the activities (such as the free-style grazing) of the first dairy animal 106a by use of the first sensing tag 410a and the image-capture device 412. An example to monitor the activities (such as the free-style grazing) of the first dairy animal 106a is described in FIG. 4B.

The processor 202 may further instruct the feed controller 206 to manage the feed of the first dairy animal 106a based on the monitored activities of the first care-taker 108a and the first dairy animal 106a. The feed controller 206 may be configured to estimate an amount of milk yielded by the first dairy animal 106a based on the hand-based milking activity performed by the first care-taker 108a for the first dairy animal 106a. The estimation of the amount of milk yielded by the first dairy animal 106a may be dependent on a duration of the hand-based milking activity performed by the first care-taker 108a and a milking capacity of the first care-taker 108a. The feed controller 206 may retrieve information pertaining to the milking capacity of the first care-taker 108a stored in the memory 204. Alternatively, the feed controller 206 may query the wearable device 406 to acquire information pertaining to milking capacity of the first care-taker 108a stored in local memory of the wearable device 406. The feed controller 206 may determine the duration of the hand-based milking activity performed by the first care-taker 108a from the received signal variations and the received digital images and/or videos.

The feed controller 206 may be configured to determine a start time instant and a stop time instant of the hand-based milking activity performed by the first care-taker 108a. The feed controller 206 may further determine the duration of hand based milking activity performed by the first care-taker 108a based on the time elapsed between the start time instant and the stop time instant of the hand-based milking activity. For example, the feed controller 206 may determine the start time instant to be “10:20:00 a.m.” and the stop time instant to be “11:00:00 a.m.” Thus, the feed controller 206 may determine the duration of hand based milking activity performed by the first care-taker 108a to be “40 minutes.” The feed controller 206 may further use the information pertaining to the milking capacity of the first care-taker 108a to estimate the amount of milk yielded by the first dairy animal 106a. For example, the milking capacity of the first care-taker 108a may be “3 liters of milk per hour.” The feed controller 206 may estimate the amount of milk yielded by the first dairy animal 106a to be “2 liters”, based on the duration of hand based milking activity performed by the first care-taker 108a (such as “40 minutes”).

The feed controller 206 may further determine the feed composition for the first dairy animal 106a based on the amount of milk yielded by the first dairy animal 106a and the monitored activities (such as the free style grazing) of the first dairy animal 106a. The feed controller 206 may further determine an amount of feed of the determined feed composition to be fed to the first dairy animal 106a. The feed controller 206 may be further configured to control the loading device 116 that may load a feed container or dispenser (such as the feed container 120), associated with the first dairy animal 106a, with the determined feed composition. The feed controller 206 may load the feed container 120 with the determined feed composition for the first dairy animal 106a to manage consumption of the determined feed composition by the first dairy animal 106a. An example to manage consumption of the determined feed composition by a specific dairy animal is described in FIG. 4C.

In accordance with an embodiment, the feed controller 206 may be configured to update the determined feed composition based on the health information of the first dairy animal 106a. The health information of the first dairy animal 106a may be received from the first sensing tag 410a associated with the first dairy animal 106a. The first sensing tag 410a may detect the one or more health parameters (such as the body temperature, the heart rate, the respiratory rate, or a combination thereof) of the first dairy animal 106a and transmit to the feed controller 206. The feed controller 206 may add required medicinal ingredients (such as antibiotics) to treat any health anomaly, if identified by the feed controller 206.

In accordance with an embodiment, the wearable device 406 may transmit the tracked set of gestures of the first care-taker 108a to the processor 302. In this scenario, the processor 302 may instruct the milk yield estimator 308 to determine the duration of the hand-based milking activity performed by the first care-taker 108a based on the start time instant and the stop time instant of the hand-based milking activity. The milk yield estimator 308 may further determine the amount of milk yielded by the first dairy animal 106a based on the duration of the hand-based milking activity performed by the first care-taker 108a and the milking capacity of the first care-taker 108a. The milk yield estimator 308 may further transmit the determined amount of milk yielded by the first dairy animal 106a to the processor 202 by the network interface 310.

In accordance with an embodiment, the processor 302 may notify the first care-taker 108a to discontinue the hand-based milking activity of the first dairy animal 106a, based on the duration of the hand-based milking activity that exceeds the milking duration threshold of the first dairy animal 106a. For example, the processor 302 may display a message on the I/O device 306 to discontinue the hand-based milking activity. In another example, the processor 302 may generate an alarm through the I/O device 306 to discontinue the hand-based milking activity.

In accordance with an embodiment, the amount of milk yielded by the first dairy animal 106a may further include an amount of milk consumed by the plurality of off-springs of the first dairy animal 106a. The processor 202 may further monitor the activities of the plurality of off-springs to determine the amount of milk consumed by the plurality of off-springs from the udder portion 404 of the first dairy animal 106a. The processor 202 may instruct the first image-capture device 412a embedded in the first sensing tag 410a of the first dairy animal 106a to monitor the milk consumption activity of the of off-springs of the first dairy animal 106a. The first image-capture device 412a may be focused at the udder portion 404 of the first dairy animal 106a. The first image-capture device 412a may capture the one or more digital images and/or videos to track the milk consumption activity of the plurality of off-springs. The first image-capture device 412a may further transmit the captured one or more digital images and/or videos to the processor 202. The processor 202 may use the received one or more digital images and/or videos and the milk consumption capacity of each of the plurality of off-springs to determine the amount of milk consumed by the plurality of off-springs from the udder portion 404 of the first dairy animal 106a. Based on a detection of a start time instant and stop time instant from the one or more digital images and/or videos, the amount of milk consumed by the plurality of off-springs from the udder portion 404, may be determined.

In accordance with an embodiment, the processor 202 may further determine the wage parameter for the first care-taker 108a based on a duration associated with the monitored activities of the first care-taker 108a. The monitored activities of the first care-taker 108a may include the hand-based milking of the plurality of dairy animals (such as the first dairy animal 106a), the cleaning of the dairy farm, and/or the collection of the animal dung from the dairy farm.

However, it should readily be understood that the scope of the disclosure is not limited to the first image-capture device 412a to be embedded in the first sensing tag 410a, as shown in the FIG. 4A. In accordance with an embodiment, the first image-capture device 412a may be strapped to other body portions, such as one of the four legs or lower portion of the stomach, of the first dairy animal 106a to focus at the udder portion 404 of the first dairy animal 106a. In accordance with an embodiment, there may be more than one image-capture devices strapped to different body portions of the first dairy animal 106a to focus at the udder portion 404 from different angles.

The determination of the feed composition for each of the plurality of dairy animals (such as the first dairy animal 106a) based on the amount of milk yielded by the each dairy animal and the monitored activities of each dairy animal, may enable the system, such as the feed-management server 112, to efficiently manage the consumption of feed by each of the plurality of dairy animals. The feed-management server 112 determines the feed composition of each of the plurality of dairy animals based on the corresponding amount of milk yielded, thus the determination of the feed composition for each dairy animal is independent from each other. The feed-management server 112 continuously monitors the health of each of the dairy animal by the plurality of sensing devices 102, such as the first sensing tag 410a, to update the feed composition based on any health anomaly that is detected in a particular dairy animal, such as the first dairy animal 106a. Unlike conventional systems, where a common feed composition is determined for the plurality of dairy animals, the feed controller 206 in the feed-management server 112 determines a targeted feed composition for each of the plurality of dairy animals based on real time monitored activities of the plurality of entities in the dairy farm.

With reference to FIG. 4B, there is shown a second example 400B of animal feed management in a dairy farm. With reference to the second example 400B, there is further shown the first dairy animal 106a, a second dairy animal 106b, and a second defined area 414. There is further shown a second sensing tag 410b that includes a second image-capture device 412b. The second sensing tag 410b may be associated with the second dairy animal 106b. There is also shown the feed-management server 112, communicatively coupled to the first sensing tag 410a and the second sensing tag 410b, via the communication network 114.

In accordance with the second example 400B, the first dairy animal 106a and the second dairy animal 106b may be engaged in the free-style grazing activity in the second defined area 414. The free-style grazing activity may refer to a grazing activity in an open grass field by the first dairy animal 106a and the second dairy animal 106b. The processor 202 may monitor the free-style grazing activity of the plurality of dairy animals, such as the first dairy animal 106a and the second dairy animal 106b, by use of the first image-capture device 412a and the second image-capture device 412b. The first image-capture device 412a and the second image-capture device 412b may capture the one or more digital images and/or videos of the first dairy animal 106a and the second dairy animal 106b, in real time. The first image-capture device 412a and the second image-capture device 412b may store the captured one or more digital images and/or videos at the first sensing tag 410a and the second sensing tag 410b, respectively. The first sensing tag 410a and the second sensing tag 410b may further transmit the captured one or more digital images and/or videos to the processor 202, via the communication network 114.

The processor 202 may monitor the activities, such as the free-style grazing activity, of the first dairy animal 106a and the second dairy animal 106b based on the received one or more digital images and/or videos. The processor 202 may further determine a start time instant and a stop time instant of the free-style grazing activity by the first dairy animal 106a and the second dairy animal 106b. The processor 202 may further determine a duration in which each of the first dairy animal 106a and the second dairy animal 106b performed the free-style grazing activity. The feed controller 206 may determine the amount of intake of food during the free-style grazing activity by each of the first dairy animal 106a and the second dairy animal 106b, based on the determined duration of the free-style grazing activity. The feed controller 206 may further determine the feed composition of each of the first dairy animal 106a and the second dairy animal 106b based on the corresponding amount of intake of food during the free-style grazing activity. The feed controller 206 may control loading of the determined feed composition for each of the first dairy animal 106a and the second dairy animal 106b in different feed containers as illustrated and described in FIG. 4C.

With reference to FIG. 4C, there is shown a third example 400C of animal feed management in a dairy farm. With reference to the third example 400C, there is further shown the first dairy animal 106a, the second dairy animal 106b, and a third defined area 416. There is further shown the first sensing tag 410a, the first image-capture device 412a, the second sensing tag 410b, and the second image-capture device 412b. There is further shown a first feed container 418a, a second feed container 418b and a loading device 420. The loading device 420 may include a first feed mixing compartment 422a and a second feed mixing compartment 422b. The first feed mixing compartment 422a contains the feed composition determined for the first dairy animal 106a and the second feed mixing compartment 422b contains the feed composition determined for the second dairy animal 106b. There is also shown the feed-management server 112, communicatively coupled to the first sensing tag 410a and the second sensing tag 410b, via the communication network 114.

In accordance with the third example 400C, the first feed container 418a may be associated with the first dairy animal 106a and the second feed container 418b may be associated with the second dairy animal 106b. The feed controller 206 may control the loading device 420 to load the determined feed composition. The loading device 420 may refer to a device that contains one or more feed mixing compartments (such as the first feed mixing compartment 422a and the second feed mixing compartment 422b), where the feed of the determined feed composition is prepared and then loaded in a feed container (such as the first feed container 418a and the second feed container 418b). Alternatively, the loading device 420 may have only one feed mixing compartment. Thus, the feed of the determined feed composition is prepared for each dairy animal (such as the first dairy animal 106a and the second dairy animal 106b) one after the other and then loaded in the corresponding feed containers (such as the first feed container 418a and the first feed container 418b). Thus, in this scenario, once the determined feed composition of the first dairy animal 106a is loaded in the first feed container 418a from the one feed mixing compartment, the feed composition determined for the second dairy animal 106b may be prepared in the one feed mixing compartment of the loading device 420. The loading device 420 may correspond to the loading device 116 including the feed mixing compartment 118 and the feed containers 118a and 118b may correspond to the feed container 120.

The loading device 420 may include the first feed mixing compartment 422a and the second feed mixing compartment 422b. One or more ingredients of the feed are mixed in accordance with the determined feed composition for the first dairy animal 106a in the first feed mixing compartment 422a. One or more ingredients of the feed are mixed in accordance with the determined feed composition for the second dairy animal 106b in the second feed mixing compartment 422b. The inflow of each of the one or more ingredients in the first feed mixing compartment 422a and the second feed mixing compartment 422b may be controlled by use of one or more valves. Each of the valves may remain open until corresponding specific ingredient is dispensed or otherwise supplied in the corresponding feed mixing compartment of the loading device 420 in accordance with the determined feed composition. For example, the determined feed composition for the first dairy animal 106a may include “80 g” of mineral mixture. The valve of the mineral mixture may thus remain open until “80 g” of the mineral mixture is dispensed or otherwise supplied in first feed mixing compartment 422a of the loading device 420. The feed controller 206 may control the operations of the valves. In an embodiment, the operations of the valves may be controlled manually. For example, the feed controller 206 may transmit a notification to the smartphone 408 associated with the first care-taker 108a to operate the valves.

The loading device 420, under the control of the feed controller 206, may load the first feed container 418a with the feed composition determined for the first dairy animal 106a from the first feed mixing compartment 422a. The loading device 420, under the control of the feed controller 206, may further load the second feed container 418b with the feed composition determined for the second dairy animal 106b from the second feed mixing compartment 422b. Thus, a customized feed composition specific to a dairy animal may be prepared. For example, 2 kg of feed composition may be loaded for consumption by the first dairy animal 106a, whereas 2.5 kg of determined feed composition may be loaded for consumption by the second dairy animal 106b. The first dairy animal 106a may then consume the determined feed from the first feed container 418a and the second dairy animal 106b may then consume the determined feed from the second feed container 418b.

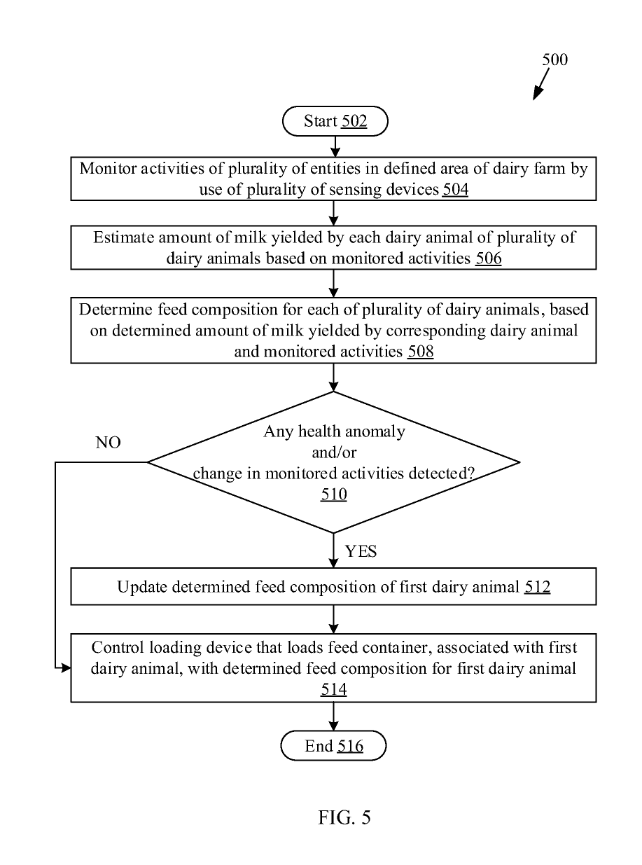

FIG. 5 is a flowchart that illustrates first exemplary operations for animal feed management in a dairy farm, in accordance with an embodiment of the disclosure. With reference to FIG. 5, there is shown a flowchart 500. The flowchart 500 is described in conjunction with elements, for example, from FIGS. 1, 2, 3, 4A, 4B, and 4C. The exemplary operations of the flowchart 500 starts at 502.

At 504, the activities of the plurality of entities in a defined area of a dairy farm may be monitored by use of the plurality of sensing devices 102. The monitored activities may include at least a free-style grazing activity by the plurality of dairy animals included in the plurality of entities. The monitored activities may further include a hand-based milking activity of the plurality of dairy animals by the plurality of care-takers and a milk consumption activity by the plurality of off-springs of the plurality of dairy animals from udder of the plurality of dairy animals. The plurality of sensing devices 102 may include a sensing tag associated with a dairy animal in the plurality of dairy animals, a wearable device associated with a care-taker in the plurality of care-takers. An example is shown and described in FIGS. 4A and 4B, where the feed controller 206 uses the plurality of sensing devices (such as the first sensing tag 410a and the second sensing tag 410b,) to monitor the free-style grazing activity of the first dairy animal 106a and the second dairy animal 106b. The feed controller 206 may further configured to utilize the plurality of sensing devices (such as the wearable device 406, and/or the first image-capture device 404a embedded in the first sensing tag 410a) to monitor the hand-based milking activity of the first dairy animal 106a by the first care-taker 108a. The feed controller 206 monitors the milk consumption activity of the plurality of off-springs from udder of the first dairy animal 106a by the plurality of sensing devices (the first image-capture device 404a embedded in the first sensing tag 410a).

At 506, the amount of milk yielded by each dairy animal of the plurality of dairy animals may be estimated based on the monitored activities. The estimated amount of milk yielded by a dairy animal may include the amount of milk collected by a care-taker from the dairy animal and the amount of milk consumed by an off-spring of the dairy animal. An example is shown and described in FIG. 4A, where the feed controller 206 estimates the amount of milk yielded by the first dairy animal 106a based on the monitored activities (such as the hand-based milking activity for the first dairy animal 106a) by the first care-taker 108a.

At 508, the feed composition for each of the plurality of dairy animals may be determined, based on the determined amount of milk yielded by corresponding dairy animal and the monitored activities. An example is shown and described in FIGS. 4A and 4B, where the feed controller 206 determines the feed composition for the first dairy animal 106a based on the amount of milk yielded by the first dairy animal 106a and the monitored activities of the first care-taker 108a, the first dairy animal 106a, and the plurality of off-springs of the first dairy animal 106a.

At 510, a check may be performed to detect any health anomaly in each of the plurality of dairy animals (such as the first dairy animal 106a) and/or a change in the monitored activities. Based on any health anomaly that is detected in the first dairy animal and/or a change that is detected in the monitored activities, control passes to 512 else control passes to 514. At 512, the determined feed composition of the first dairy may be updated by the feed controller 206. An example is described in FIG. 4A, where the feed controller 206 may update the determined feed composition of the first dairy animal 106a based on the detection of the health anomaly in the first dairy animal 106a.

At 514, a loading device that loads a feed container with the determined feed composition for the first dairy animal 106a may be controlled to manage consumption of the feed composition by the first dairy animal 106a. The feed container may be associated with the first dairy animal 106a of the plurality of dairy animals. An example is shown and described in FIG. 4C, where the feed controller 206 controls the loading device 420 to load the first feed container 418a associated with the first dairy animal 106a with the determined feed composition for the first dairy animal 106a. The feed controller 206 may be further configured to control the loading device 420 to load the second feed container 418b associated with the second dairy animal 106b with the determined feed composition for the second dairy animal 106b. The control may pass to end 516.

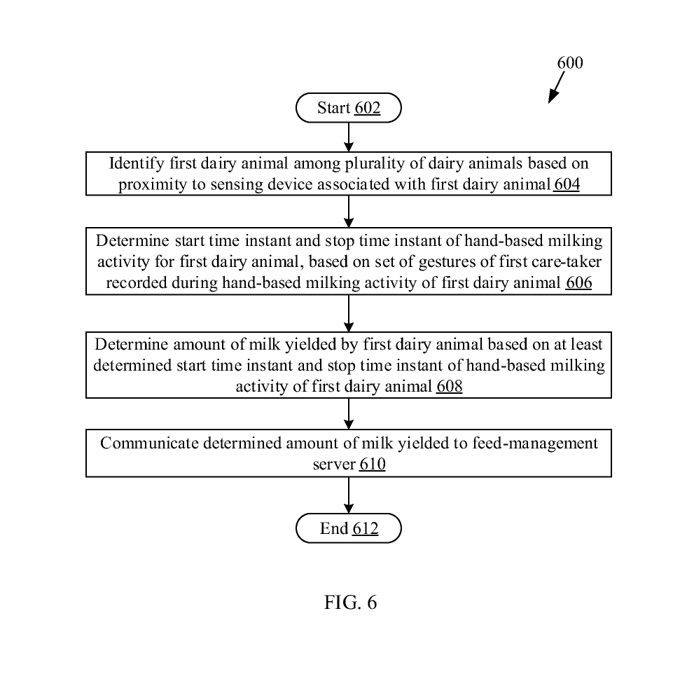

FIG. 6 is a flowchart that illustrates second exemplary operations for animal feed management in a dairy farm, in accordance with an embodiment of the disclosure. With reference to FIG. 6, there is shown a flowchart 600. The flowchart 600 is described in conjunction with elements, for example, from FIGS. 1, 2, 3, and 4A to 4C. The exemplary operations of the flowchart 600 starts at 602 and proceeds to 604.

At 604, the first dairy animal 106a among the plurality of dairy animals may be identified based on a proximity to the sensing device, such as the sensing tag 102a, associated with the first dairy animal 106a. An example is shown and described in FIG. 4A, where the processor 302 identifies the first dairy animal 106a based the proximity of the electronic device 110 to the first sensing tag 410a associated with the first dairy animal 106a.

At 606, a start time instant and a stop time instant of a hand-based milking activity for the first dairy animal may be determined, based on a set of gestures of a first care-taker recorded during the hand-based milking activity of the first dairy animal. An example is shown and described in FIG. 4A, where the processor 302 determines the start time instant and the stop time instant of the hand-based milking activity for the first dairy animal 106a. The processor 302 determines the start time instant and the stop time instant, based on the set of gestures of the first care-taker 108a recorded by the wearable device 406 and/or the first image-capture device 412a during the hand-based milking of the first dairy animal 106a.

At 608, the amount of milk yielded by the first dairy animal 106a may be determined based on at least the determined start time instant and the stop time instant of the hand-based milking activity of the first dairy animal 106a. An example is shown and described in FIG. 4A, where the milk yield estimator 308 determines the amount of milk yielded by the first dairy animal 106a based on at least the determined start time instant and the stop time instant of the hand-based milking activity of the first dairy animal 106a performed by the first care-taker 108a.

At 610, the determined amount of milk yielded may be communicated to the feed-management server 112. The feed-management server 112 may be configured to determine the feed composition for the first dairy animal 106a based on the communicated amount of milk yielded. The feed-management server 112 may be further configured to control a loading device that loads a feed container, associated with the first dairy animal 106a, with the determined feed composition to manage consumption of the feed composition by the first dairy animal 106a. An example is shown and described in FIGS. 4A and 4C, where the processor 302 communicates the amount of milk yielded, determined by the milk yield estimator 308, to the processor 202 of the feed-management server 112. The feed controller 206 of the feed-management server 112 may be configured to control the loading device 420 that loads the first feed container 418a and the second feed container 418b, associated with the first dairy animal 106a and the second dairy animal 106b respectively, with the corresponding feed composition to manage consumption of the feed composition by the two dairy animals (i.e., the first dairy animal 106a and the second dairy animal 106b). The control passes to end 612.

In accordance with an embodiment of the disclosure, a system for animal feed management for a dairy farm is disclosed. The system, such as the feed-management server 112 (FIG. 1) may include one or more circuits (such as the processor 202 and the feed controller 206 (FIG. 2)) that may be communicatively coupled to a plurality of sensing devices (such as the sensing tag 102a and the wearable device 102b (FIG. 1)). The processor 202 may be configured to monitor activities of a plurality of entities (such as the first dairy animal 106a and the first care-taker 108a (FIG. 1 and FIG. 4A)) in a defined area (such as the first defined area 402 (FIG. 4A) and the second defined area 414 (FIG. 4B)) of a dairy farm by use of the plurality of sensing devices, where the monitored activities include at least a free-style grazing activity by a plurality of dairy animals (such as the first dairy animal 106a and the second dairy animal 106b (FIG. 4B)) included in the plurality of entities. The feed controller 206 may be further configured to estimate an amount of milk yielded by each dairy animal (such as the first dairy animal 106a) of the plurality of dairy animals based on the monitored activities. The feed controller 206 may be further configured to determine a feed composition for each of the plurality of dairy animals (such as the first dairy animal 106a and the second dairy animal 106b), based on the determined amount of milk yielded by corresponding dairy animal and the monitored activities. The feed controller 206 may control a loading device (such as the loading device 420 (FIG. 4C)) that loads a feed container (such as the first feed container 418a), associated with a first dairy animal (such as the first dairy animal 106a) of the plurality of dairy animals, with the determined feed composition for the first dairy animal 106a to manage consumption of the feed composition by the first dairy animal 106a.

In accordance with yet another embodiment of the disclosure, a system for animal feed management for a dairy farm is disclosed. The system, such as the electronic device 110 (FIG. 1)) may comprise one or more circuits (such as the processor 302 and the milk yield estimator 308 (FIG. 3)) communicatively coupled to a feed-management server (such as the feed-management server 112) and a sensing device (such as the sensing tag 102a (FIG. 1)). The processor 302 may be configured to identify a first dairy animal (such as the first dairy animal 106a) among a plurality of dairy animals based on a proximity to the sensing device (the sensing tag 102a) associated with the first dairy animal 106a. The processor 302 may be configured to determine a start time instant and a stop time instant of a hand-based milking activity for the first dairy animal 106a based on a set of gestures of a first care-taker (such as the first care-taker 108a (FIG. 1)) recorded during the hand-based milking activity of the first dairy animal 106a. The first care-taker 108a may be associated with the electronic device 110. The milk yield estimator 308 may further determine an amount of milk yielded by the first dairy animal 106a based on at least the determined start time instant and the stop time instant of the hand-based milking activity of the first dairy animal 106a. The milk yield estimator 308 may further communicate the determined amount of milk yielded to the feed-management server 112. The feed-management server 112 may be configured to determine a feed composition for the first dairy animal 106a based on the communicated amount of milk yielded. The feed-management server 112 may be configured to control a loading device (such as the loading device 420 (FIG. 4C)) that loads a feed container (such as the first feed container 418a (FIG. 4C)), associated with the first dairy animal 106a, with the determined feed composition to manage consumption of the feed composition by the first dairy animal 106a.

Various embodiments of the disclosure may provide a non-transitory, computer readable medium and/or storage medium, and/or a non-transitory machine readable medium and/or storage medium stored thereon, a machine code and/or a set of instructions executable by a machine and/or a computer for animal feed management. The set of instructions may cause the machine and/or computer to perform the operations that comprise monitoring of activities of a plurality of entities in a defined area of a dairy farm by use of the plurality of sensing devices 102. The monitored activities may include at least a free-style grazing activity by a plurality of dairy animals included in the plurality of entities. An amount of milk yielded by each dairy animal of the plurality of dairy animals may be estimated based on the monitored activities. A feed composition for each of the plurality of dairy animals may be determined, based on the determined amount of milk yielded by corresponding dairy animal and the monitored activities. A loading device that loads a feed container, associated with a first dairy animal 106a of the plurality of dairy animals, with the determined feed composition for the first dairy animal 106a may be controlled to manage consumption of the feed composition by the first dairy animal 106a.

In conventional animal feed management systems, a common feed composition is determined for a plurality of dairy animals based on an aggregate amount of milk yielded by the plurality of dairy animals. For example, in a dairy farm a first dairy animal may yield “10 liters” of milk per day and a second dairy animal may yield only “4 liters” of milk per day. The aggregate amount of milk yielded by both the dairy animals is “14 liters”. The conventional animal feed management systems may determine the feed composition for both the dairy animals based on the aggregate amount of milk yielded (i.e., “14 liters”). In this scenario, the individual nutrition requirements of each dairy animal may be overlooked. This may lead to deterioration of the milk yielding capacity of the plurality of dairy animals. Further, the efficient management of a plurality of care-takers of the dairy farm may also pose a challenge.

The disclosed system, such as the feed-management server 112, comprises one or more circuits, such as the processor 202 and the feed controller 206. The one or more circuits in the feed-management server 112 monitors the real time activities of the plurality of entities in a dairy farm by the plurality of sensing devices 102. The plurality of entities may include the plurality of dairy animals, the plurality of care-takers, and the plurality of off-springs of the plurality of dairy animals. Thus, the disclosed system provides a capability of automated monitoring of plurality of entities, in a cost-effective manner. For example, the plurality of care-takers are paid based on the activities performed. Further, less number of care-takers may be required for monitoring the activities of the plurality of dairy animals and the corresponding off-springs. Also, the automated management of dairy animals provides a proper utilization of time and resources, such as the plurality of care-takers, for management of the plurality of dairy animals. The feed controller 206 in the disclosed system further enables the estimation of the milk yielded by individual dairy animal in the plurality of dairy animals. The feed controller 206 further determines a feed composition for each dairy animal based on the corresponding amount of milk yielded. Thus, the disclosed system ensures that the feed composition determination of each of the plurality of dairy animals is independent of each other and customized for different dairy animals.

The disclosed system further enables an automatic inspection of health of the plurality of dairy animals by the plurality of health sensors of the sensing tag 102a. The feed controller 206 in the disclosed system further updates the determined feed composition of each of the plurality of dairy animals based on the corresponding health statistics. Various medicinal ingredients may be added to the determined feed composition to treat any health anomaly detected in a particular dairy animal. Along with the animal feed management, the disclosed system provides an ability to determine an amount of milk consumed by the plurality of off-springs of the plurality of dairy animals.

Also, the wage parameter of each of the plurality of care-takers is determined based on the activities performed by each of the plurality of care-takers. Thus, the disclosed system, such as the feed-management server 112, determines the wage parameter for a care-taker based on a time duration spent by the care-taker in performing one or more activities for managing the dairy farm.

Various embodiments of the disclosure may provide a non-transitory, computer readable medium and/or storage medium, and/or a non-transitory machine readable medium and/or storage medium stored thereon, a machine code and/or a set of instructions executable by a machine and/or a computer for animal feed management. The set of instructions may cause the machine and/or computer to perform the operations that comprise identification of the first dairy animal 106a among a plurality of dairy animals based on a proximity to the sensing device associated with the first dairy animal 106a. A start time instant and a stop time instant of a hand-based milking activity for the first dairy animal 106a may be determined based on a set of gestures of the first care-taker 108a recorded during the hand-based milking activity of the first dairy animal 106a. The first care-taker 108a may be associated with the electronic device 110. An amount of milk yielded by the first dairy animal 106a may be determined based on at least the determined start time instant and the stop time instant of the hand-based milking activity of the first dairy animal 106a. The determined amount of milk yielded may be communicated to feed-management server 112. The feed-management server 112 may be configured to determine a feed composition for the first dairy animal 106a based on the communicated amount of milk yielded. The feed-management server 112 may be further configured to control a loading device that loads a feed container, associated with the first dairy animal 106a, with the determined feed composition to manage consumption of the feed composition by the first dairy animal 106a. Further, unlike the conventional systems, the information related to milking yield, previous feed in-take by a dairy animal, and the like, is also stored in the sensing tag of each dairy animal and also at the wearable device of each care-taker. Thus, in case of a communication network failure, the loading device 420 and/or the feed-management server 112 may retrieve such information by an alternative short range communication, such as Bluetooth or Wi-Fi communication protocol, based on a proximity to the sending tag. The feed container associated with a dairy animal may then be loaded with appropriate feed composition. Thus, a fail-safe feed management system is provided.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. An animal feed management system, comprising:
one or more circuits in a feed-management server communicatively coupled to a plurality of sensing devices, wherein said one or more circuits are configured to:
monitor activities of a plurality of entities in a defined area of a dairy farm by use of said plurality of sensing devices, wherein said monitored activities include at least a free-style grazing activity by a plurality of dairy animals included in said plurality of entities;
estimate an amount of milk yielded by each dairy animal of said plurality of dairy animals based on said monitored activities;
determine a feed composition for each of said plurality of dairy animals, based on said determined amount of milk yielded by corresponding dairy animal and said monitored activities; and
control a loading device that loads a feed container, associated with a first dairy animal of said plurality of dairy animals, with said determined feed composition for said first dairy animal to manage consumption of said feed composition by said first dairy animal.

2. The animal feed management system of claim 1, wherein said monitored activities of said plurality of entities further include activities of a plurality of care-takers, and activities of a plurality of off-springs of said plurality of dairy animals.

3. The animal feed management system of claim 2, wherein said plurality of sensing devices includes a wearable device associated with each of said plurality of care-takers.

4. The animal feed management system of claim 2, wherein said plurality of sensing devices includes a sensing tag that comprises an embedded camera associated with each of said plurality of dairy animals.

5. The animal feed management system of claim 2, wherein said monitored activities of said plurality of care-takers corresponds to a hand-based milking activity of said plurality of dairy animals by said plurality of care-takers and said monitored activities of said plurality of off-spring corresponds to a milk consumption activity by said plurality of off-springs from udder of said plurality of dairy animals.

6. The animal feed management system of claim 5, wherein said one or more circuits are further configured to compute a wage parameter for said plurality of care-takers based on said monitored activities of said plurality of care-takers.

7. The animal feed management system of claim 1, wherein said one or more circuits are further configured to determine an amount of feed of said determined feed composition for each of said plurality of dairy animals.

8. The animal feed management system of claim 1, wherein said one or more circuits are further configured to update said determined feed composition based on health information of said plurality of dairy animals received from said plurality of sensing devices associated with said plurality of dairy animals.

9. The animal feed management system of claim 1, wherein said determined feed composition is further updated based on a change in said determined amount of milk yielded by each dairy animal of said plurality of dairy animals or said monitored activities.

10. An animal feed management system, comprising:
one or more circuits in an electronic device communicatively coupled to a feed-management server and a sensing device, said one or more circuits are configured to:
identify a first dairy animal among a plurality of dairy animals based on a proximity to said sensing device associated with said first dairy animal;
determine a start time instant and a stop time instant of a hand-based milking activity for said first dairy animal based on a set of gestures of a first care-taker recorded during said hand-based milking activity of said first dairy animal, wherein said first care-taker is associated with said electronic device;
determine an amount of milk yielded by said first dairy animal based on at least said determined start time instant and said stop time instant of said hand-based milking activity of said first dairy animal; and
communicate said determined amount of milk yielded to said feed-management server, wherein said feed-management server is configured to determine a feed composition for said first dairy animal based on said communicated amount of milk yielded, and wherein said feed-management server is configured to control a loading device that loads a feed container, associated with said first dairy animal, with said determined feed composition to manage consumption of said feed composition by said first dairy animal.

11. The animal feed management system of claim 10, wherein said determination of said amount of milk yielded by said first dairy animal is further based on a free-style grazing activity by said first dairy animal in a grazing area and an amount of milk consumed from udder of said first dairy animal by one or more off-springs of said first dairy animal.

12. The animal feed management system of claim 10, wherein said one or more circuits are further configured to track said set of gestures of said first care-taker, in an event said first care-taker performs said hand-based milking activity of said first dairy animal.

13. The animal feed management system of claim 12, wherein said set of gestures of said first care-taker are further tracked by said sensing device associated with said first dairy animal.

14. The animal feed management system of claim 12, wherein said set of gestures of said first care-taker are tracked in real time or near real time.

15. The animal feed management system of claim 10, wherein said one or more circuits are further configured to generate a notification to notify said first care-taker to discontinue said hand-based milking of said first dairy animal, in an event a time duration of said hand-based milking activity exceeds a defined milking duration threshold of said first dairy animal.

16. An animal feed management method, comprising:
monitoring, by one or more circuits in a feed-management server, activities of a plurality of entities in a defined area of a dairy farm by use of a plurality of sensing devices that is communicatively coupled to said one or more circuits, wherein said monitored activities include at least a free-style grazing by a plurality of dairy animals included in said plurality of entities;
estimating, by said one or more circuits, an amount of milk yielded by each dairy animal of said plurality of dairy animals based on said monitored activities;
determining, by said one or more circuits, a feed composition for each of said plurality of dairy animals, based on said determined amount of milk yielded by corresponding dairy animal and said monitored activities; and
controlling, by said one or more circuits, a loading device that loads a feed container, associated with a first dairy animal of said plurality of dairy animals, with said determined feed composition for said first dairy animal to manage consumption of said feed composition by said first dairy animal.

17. The animal feed management method of claim 16, wherein said monitored activities of said plurality of entities further include activities of a plurality of care-takers, and activities of a plurality of off-springs of said plurality of dairy animals.

18. The animal feed management method of claim 17, wherein said monitored activities further include a hand-based milking activity of said plurality of dairy animals by said plurality of care-takers and a milk consumption activity by said plurality of off-springs from udder of said plurality of dairy animals.

19. The animal feed management method of claim 18, further comprising updating, by said one or more circuits, said determined feed composition, based on a change in said determined amount of milk yielded by each dairy animal of said plurality of dairy animals or said monitored activities.

20. An animal feed management method, comprising:
identifying, by one or more circuits in an electronic device, a first dairy animal among a plurality of dairy animals based on a proximity to a sensing device associated with said first dairy animal, wherein said sensing device is communicatively coupled to said electronic device;
determining, by said one or more circuits, a start time instant and a stop time instant of a hand-based milking activity for said first dairy animal based on a set of gestures of a first care-taker recorded during said hand-based milking activity of said first dairy animal, wherein said first care-taker is associated with said electronic device;
determining, by said one or more circuits, an amount of milk yielded by said first dairy animal based on at least said determined start time instant and said stop time instant of said hand-based milking activity of said first dairy animal; and
communicating, by said one or more circuits, said determined amount of milk yielded to a feed-management server, wherein said feed management-server is configured to determine a feed composition for said first dairy animal based on said received amount of milk yielded by said first dairy animal, wherein said feed-management server is configured to control a loading device that loads a feed container, associated with said first dairy animal, with said determined feed composition to manage consumption of said feed composition by said first dairy animal.
